(19) United States
(12) Patent Application Publication
(10) Pub. No.: US 2007/0252401 A1
(43) Pub. Date: Nov. 1, 2007

(54) Rear baggage compartment structure of vehicle

(75) Inventors: Kazue Sumida, Hiroshima (JP); Minoru Toyota, Hiroshima (JP); Akira Ito, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION

(21) Appl. No.: 11/730,971

(22) Filed: Apr. 5, 2007

(30) Foreign Application Priority Data
Apr. 28, 2006 (JP) 2006-124647
Apr. 28, 2006 (JP) 2006-124648

(51) Int. Cl. B60R 5/04

(52) U.S. Cl. 296/37.5; 297/378.1

(57) ABSTRACT

A seat back is configured to be folded on a seat cushion, a baggage-compartment board is provided in a baggage compartment so as to be supported to move vertically, and there is provided a linkage mechanism to operate the seat back to be folded as the baggage-compartment board moves upward. Accordingly, the seat back can be folded on the seat cushion as the baggage-compartment board moves upward and a difference in level between a back face of the folded seat back and a baggage-compartment floor can be diminished, so operability at a baggage loading can be improved.

### BACKGROUND OF THE INVENTION

The present invention relates to a rear baggage compartment structure of a vehicle, in which a seat with a seat cushion and a seat back is provided on a floor panel of a vehicle body, and a baggage compartment is formed behind the seat.

Conventionally, a seat (rear seat) structure, in which a seat cushion is configured to be independent from a seat back and to move forward via a pair of links, and the seat back is supported via a reclining pivotal axis so as to be substantially horizontally folded on a sitting face of the seat cushion that has moved forward, whereby a passenger compartment and a rear baggage compartment behind the rear seat can be made continuous and thereby a baggage space can be properly enlarged, is known (see Japanese Patent Laid-Open Publication No. 2004-359158). The structure disclosed in this patent publication, however, does not disclose a baggage-compartment board that may allow any baggage to be placed thereon.

Meanwhile, another seat structure, in which a tonneau cover is provided behind a rear seat via a case extending in a vehicle width direction and a sheet member is provided between a hook at a back face of the rear seat and the case, is known. Herein, when the seat back is in an upright position, the above-described sheet member is bent in a U shape. When the seat back is folded forward, the above-described sheet member is disposed so as to extend between the seat back that has been folded forward and the above-described case, so a baggage compartment (rear baggage compartment) may be divided into upper and lower parts via the sheet member (see Japanese Patent Laid-Open Publication No. 6-270745). Herein, the sheet member disclosed in this patent publication can partition the rear baggage compartment with a linkage of movement of the seat, but the sheet member may not allow any baggage to be placed thereon.

Herein, it may be required to form a flat baggage compartment when the seat back is folded on the seat cushion of the rear seat. However, since there generally exists a difference in level between the upper face of the seat back that has been folded on the seat cushion and a baggage-compartment floor, it has been difficult to improve usage of the baggage compartment.

### SUMMARY OF THE INVENTION

The present invention has been devised in view of the above-described matter, and an object of the present invention is to provide a rear baggage compartment structure of a vehicle that can move a seat back to be folded on the seat cushion as a baggage-compartment board moves upward and diminish a difference in level between a back face of the folded seat back and a baggage-compartment floor, thereby improving operability at a baggage loading.

According to the present invention, there is provided a joining method, in which a rear baggage compartment structure of a vehicle, comprising a seat provided on a floor panel of a vehicle body, the seat including a seat cushion and a seat back, the seat being configured to be foldable in such a manner that the seat back is folded on the seat cushion, a baggage compartment formed behind the seat, a baggage-compartment board provided in the baggage compartment, the board being supported so as to move at least vertically, and a linkage mechanism to operate the seat back of the seat to be folded on the seat cushion as the baggage-compartment board moves upward.

The above-described seat may be a rear seat, and the above-described floor panel on which the seat is placed may be a kick-up floor portion. It is preferable that the above-described baggage-compartment board be a board that has a certain rigidity enough to allow a baggage to be placed thereon. According to the above-described structure, the seat back can be folded on the seat cushion as the baggage-compartment board moves upward, and the difference in level between the back face of the folded seat back and the baggage-compartment floor can be diminished. Thereby, the operability at the baggage loading (unloading) can be improved.

According to an embodiment of the present invention, a back face of the seat back in a folded state and an upper face of the baggage-compartment board that has moved upward form a substantially continuous baggage-compartment face. Thereby, both diminishing the difference in level and usage improvement of the baggage compartment can be attained by forming the substantially continuous baggage-compartment face.

According to another embodiment of the present invention, the linkage mechanism comprises a control mechanism to select a linkage of movements of the seat back and the baggage-compartment board or a non-linkage thereof. Thereby, in particular, the baggage-compartment board can be move vertically independently from the seat back by selecting the above-described non-linkage of movements.

According to another embodiment of the present invention, the control mechanism is operated by an operation of a passenger. Thereby, selection of the linkage or the non-linkage of movements can be attained by the passenger at need.

According to another embodiment of the present invention, the control mechanism is configured such that the baggage-compartment board does not move as the seat back is moved to be folded on the seat cushion. Thereby, the seat back can be folded independently.

According to another embodiment of the present invention, the control mechanism is configured such that when the seat back is operated to a use state thereof after the seat back has been folded on the seat cushion, the non-linkage of movements of the baggage-compartment board and the seat back is selected. Thereby, the seat back can be moved from its folded state (laying position) to its use state (upright position), keeping the baggage-compartment board moved upward. Thus, a return movement of the seat back to its used state can be attained while the baggage is placed on the baggage-compartment board moved upward.

According to another embodiment of the present invention, the linkage mechanism comprises an operational portion that is provided so as to be operative from a side of the baggage-compartment board to select a linkage of movements of the seat back and the baggage-compartment board or a non-linkage thereof. Thereby, the selection of linkage or non-linkage of movements can be attained by using the operation portion located on the side of the baggage-compartment board at the upward/downward movement of the baggage-compartment board, so the operability can be improved.

According to another embodiment of the present invention, the linkage mechanism comprises a control mechanism that limits a linkage of movement of the baggage-compartment board with respect to movement of the seat back, allowing a linkage of movement of the seat back with respect to movement of the baggage-compartment board. Thereby, the seat back can be folded independently, and there can be provided a deep and large baggage compartment with the seat back that is folded and the baggage-compartment board that is located below.

According to another embodiment of the present invention, the linkage mechanism comprises a control mechanism that limits a linkage of movement of the baggage-compartment board with respect to movement of the seat back when the seat back is operated to a use state thereof after the seat back has been folded on the seat cushion, allowing a linkage of movement of the baggage-compartment board with respect to movement of the seat back toward a folded state. Thereby, the seat back can be returned to its use state, keeping the baggage-compartment board moved upward. Namely, both passenger's sitting in the seat and baggage loading onto the baggage-compartment board can be attained.

According to another embodiment of the present invention, the linkage mechanism comprises a control mechanism that limits a linkage of movement of the baggage-compartment board with respect to movement of the seat back when the seat back is moved toward a folded state and when the seat back is operated to a use state thereof after the seat back has been folded on the seat cushion. Thereby, ensuring the linkage of movements of the baggage-compartment board and the seat back with the linkage mechanism, the seat back can be folded independently or returned from its folded state to its use state with the control mechanism.

According to another embodiment of the present invention, the control mechanism comprises an operational portion to select a linkage state or a linkage limitation state, which is selected by an operation of a passenger. Thereby, selection of linkage or linkage limitation (non-linkage) of movements can be conduced easily with a passenger's operation of the operational portion at need, so operability at the baggage loading or passenger's additional ingress can be improved.

Other features, aspects, and advantages of the present invention will become apparent from the following description which refers to accompanying drawings.

### BRIEF DESCRIPTION OF THE DRAWINGS

FIG. 1 is a schematic side view of a vehicle with a rear baggage compartment structure.

FIG. 2 is a perspective view showing the rear baggage compartment structure of a vehicle.

FIG. 3 is an enlarged side view of a major portion of FIG. 2.

FIG. 4 is a sectional view taken along line A-A of FIG. 3.

FIG. 5 is a partial enlarged view of FIG. 3, showing a limitation mode.

FIG. 6 is an explanatory diagram showing a linkage mode.

FIG. 7 is a side view showing a linkage of an upward movement of a baggage-compartment board and a folding movement of a seat back.

FIG. 8 is a perspective view of FIG. 7.

FIG. 9 is a side view showing limitation of the linkage of the movement of the baggage-compartment board and the folding movement of the seat back.

FIG. 10 is a side view showing the limitation of the linkage of the movement of the baggage-compartment board at the time of returning of the seat back.

FIG. 11 is a perspective view showing another embodiment of the rear baggage compartment structure of a vehicle.

FIG. 12 is a system diagram showing the rear baggage compartment structure of a vehicle.

FIG. 13 is a perspective view showing a linkage of the folding movement of the seat back and the upward movement of the baggage-compartment board.

FIG. 14 is a perspective view showing further another embodiment of the rear baggage compartment structure of a vehicle.

FIG. 15 is an enlarged side view of a major portion of FIG. 14.

FIG. 16 is a sectional view taken along line B-B of FIG. 15.

FIG. 17 is a partial enlarged view of FIG. 15.

FIG. 18 is a perspective view showing a linkage of the folding movement of the seat back and the upward movement of the baggage-compartment board.

FIG. 19 is a side view showing another embodiment of a pulley disposition structure.

### DETAILED DESCRIPTION OF THE INVENTION

Hereinafter, preferred embodiments will be described referring to the accompanying drawings. It should be understood that even though embodiments are separately described, single features thereof may be combined to additional embodiments.

### Embodiment 1

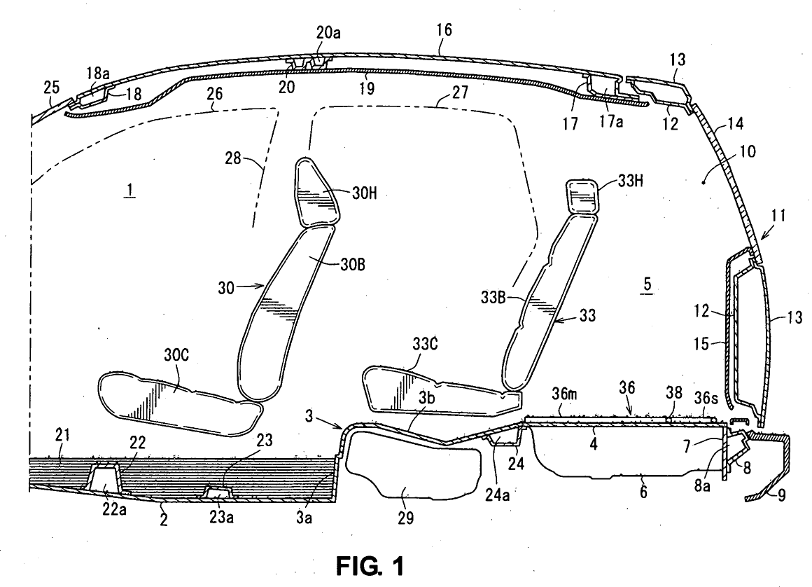

Figures show a rear baggage compartment structure of a vehicle. A vehicle body structure will be described first referring to FIG. 1. In FIG. 1, a floor panel 2 to form a floor face (bottom face) of a vehicle compartment 1 is provided, and at a rear portion of the floor panel 2 is provided a kick-up portion 3.

The kick-up portion 3 comprises a vertical wall portion 3a that rises from the floor panel 2 and a kick-up floor portion 3b that extends rearward from the vertical wall portion 3a. Behind the kick-up floor portion 3b is formed a baggage-compartment floor 4 that extends rearward and horizontally. A rear baggage compartment 5 is formed above the baggage-compartment floor 4, and a concave spare tire pan is formed at a central or middle portion of the baggage-compartment floor 4, where a spare tire is stored.

Further, a rear end panel 7 that extends in a vehicle width direction is attached to a rear open end of the spare tire pan. To a rear face of the rear end panel 7 is fixed a rear end member 8 that extends in the vehicle width direction. Thus, a rear end closed cross section 8a that extends in the vehicle width direction is formed between the rear end member 8 and the rear end panel 7, thereby ensuring a necessary rigidity of a rear vehicle body. A rear bumper 9 is disposed behind the rear end member 8.

At a rear of the rear baggage compartment 5 is provided a rear baggage-compartment opening 10, which is closed or opened by a rear gate 11. Thus, a rear hatch back type of vehicle is provided. The rear gate 11 comprises a rear gate inner panel 12, a rear gate outer panel 13, and a rear window 14. A rear gate trim 15, as an interior trim, covers a specified portion inside the vehicle that faces the rear baggage compartment 5.

Meanwhile, to a rear end portion of a roof panel 16 is fixed a rear header 17 (vehicle body rigidity member) that extends in the vehicle width direction. A header closed cross section 17a that extends in the vehicle width direction is formed between the rear end portion of the roof panel 16 and the rear header 17, thereby ensuring a necessary rigidity of the rear vehicle body. The above-described rear gate 11 is pivotally supported via a hinge member (not illustrated) that is provided right behind the header closed cross section 17a.

Likewise, to a front end portion of the roof panel 16 is fixed a front header 18 (vehicle body rigidity member) that extends in the vehicle width direction. A header closed cross section 18a that extends in the vehicle width direction is formed between the front end portion of the roof panel 16 and the front header 18, thereby ensuring a necessary rigidity of a front vehicle body. A top ceiling 19, as an interior trim, covers the inside of the above-described front header 18, roof panel 16 and rear header 17 as shown in FIG. 1.

Further, to a middle portion of the roof panel 16 is fixed a roof reinforcement 20 (vehicle body rigidity member) that extends in the vehicle width direction. A closed cross section 20a that extends in the vehicle width direction is formed between the roof reinforcement 20 and the roof panel 16, thereby ensuring a necessary rigidity of a roof portion.

Between a dash lower panel (dash panel) and the vertical wall portion 3a of the kick-up portion 3a on the floor panel 2 is provided a tunnel portion 21 that extends in a longitudinal direction of the vehicle and projects toward the inside of the vehicle compartment 1.

The tunnel portion 21 is a member that can primarily provide a floor rigidity. A plurality of floor cross members 22, 23 (vehicle body rigidity member) are provided so as to extend in the vehicle width direction separately from each other between both-side wall portions of the tunnel portion 21 and side sills (specifically, side sill inners) that extend in the longitudinal direction at both sides and have respective closed cross sections. Thus, closed cross section 22a, 23a that extend in the vehicle width direction are respectively formed between the floor cross members 22, 23 and the floor panel 2, thereby ensuring a necessary rigidity of a lower vehicle body.

Further, a rear cross member 24 (vehicle body rigidity member) is fixed to a lower face of a rear portion behind the kick-up floor portion 3b and a lower face of the front end portion of the baggage-compartment floor 4 (bottom face of the rear baggage compartment 5). Thus, a closed cross section 24a that extends in the vehicle width direction is formed between the portions 3b, 24, thereby ensuring the necessary rigidity of the lower vehicle body.

In the figures, a reference character 25 denotes a windshield, a reference character 26 denotes a front door, a reference character 27 denotes a rear door, a reference character 28 denotes a center pillar as a vehicle body rigidity member, and a reference character 29 denotes a fuel tank that is disposed below the kick-up portion 3 as one of large-scaled vehicle parts.

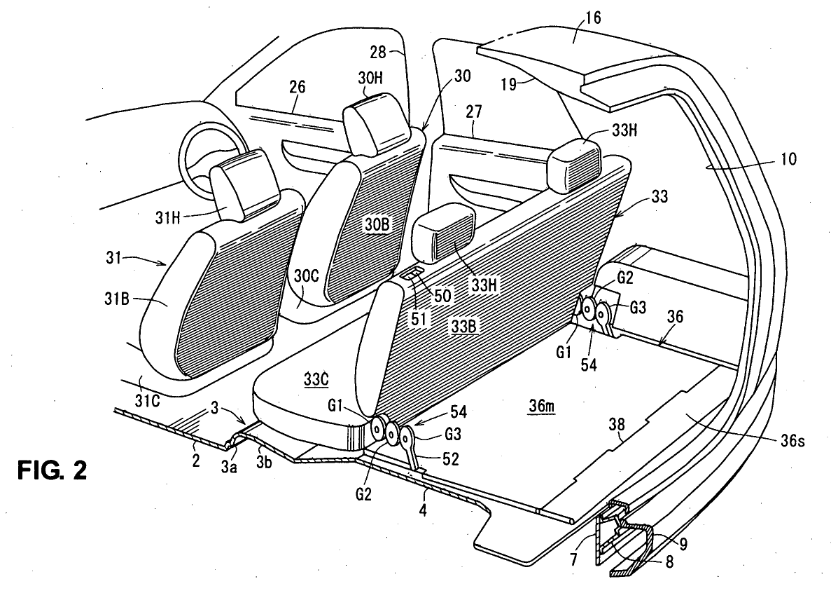

On the floor panel 2 are provided, as shown in FIGS. 1 and 2, a driver's seat 30H equipped with a seat cushion 30C, a seat back 30B and a headrest 30H, and a assistant's seat 31 equipped with a seat cushion 31C, a seat back 31B and a headrest 31H.

Further, on the kick-up floor portion 3b is a bench-type rear seat 33 equipped with a seat cushion 33C, a seat back 33B and plural headrests 30H, 30H. The above-described rear baggage compartment 5 is formed behind this rear seat 33. This rear seat 33 is configured such that its seat back 33B is foldable on its seat cushion 33C.

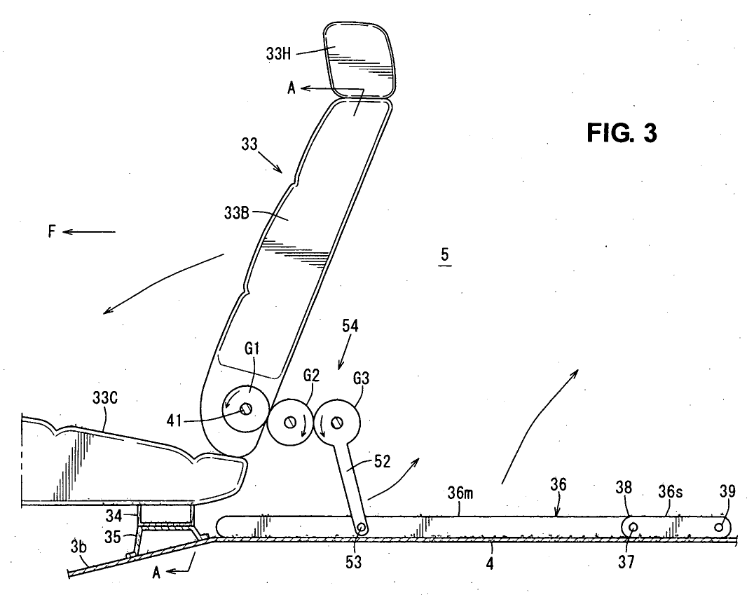

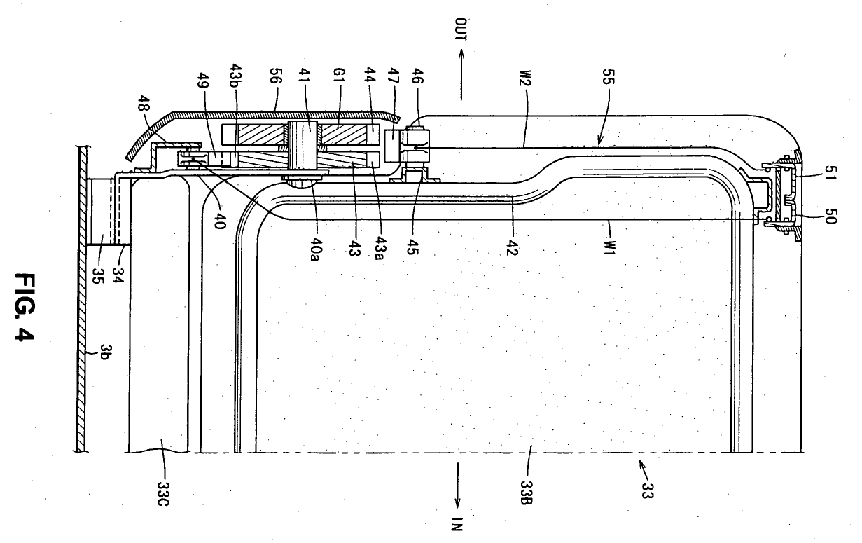

Next, the rear baggage compartment structure of a vehicle will be described in detail. FIG. 3 is an enlarged side view of a major portion of FIG. 2. FIG. 4 is a sectional view taken along line A-A of FIG. 3. The above-described seat cushion 33C is supported at the kick-up floor portion 3b via brackets 34, 35. Meanwhile, a baggage-compartment board 36 is provided above the baggage-compartment floor 4 so as to move at least vertically and allow any baggage to be placed thereon.

The above-described baggage-compartment board 36 comprises a front main board 36m and a rear sub board 36s that are split separately as shown in FIGS. 2 and 3. These both boards 36m, 36s are pivotally coupled to each other via a hinge portion 38 including a hinge pin 37. A pin 39, which is provided at a base portion of the sub board 36s, is pivotally supported at the baggage-compartment floor 4.

There is provided, as shown in FIG. 4, a support plate 40 that extends upward from the bracket 34 at a lower portion of the seat cushion 33C to a side-face lower portion of the seat back 33B along a side face of the seat cushion 33C. A rotational axis 41 is pivotally supported at a journal portion 40a that is provided at an upper portion of this support plate 40.

The rotational axis 41 is fixed to and projects outward from a seat back frame 42. The seat back 33B is rotatable around the rotational axis 41. This rotational axis 41 is configured to rotate as the seat back 33B rotates, and the seat back frame 42 and the seat back 33B are configured to rotate together unitarily with this rotation of the rotational axis 41.

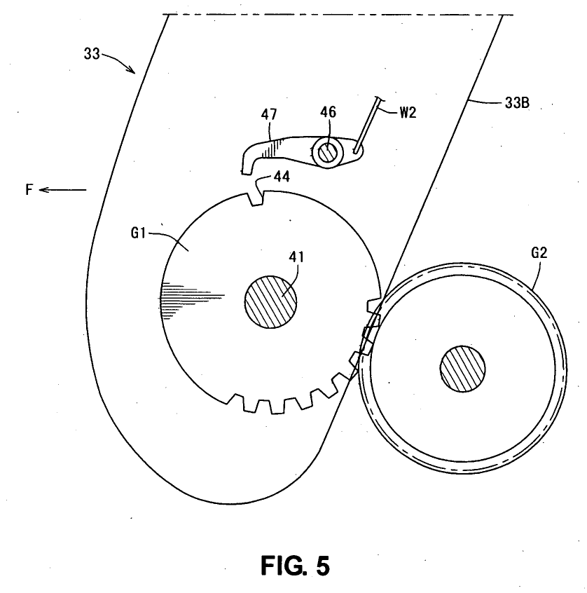

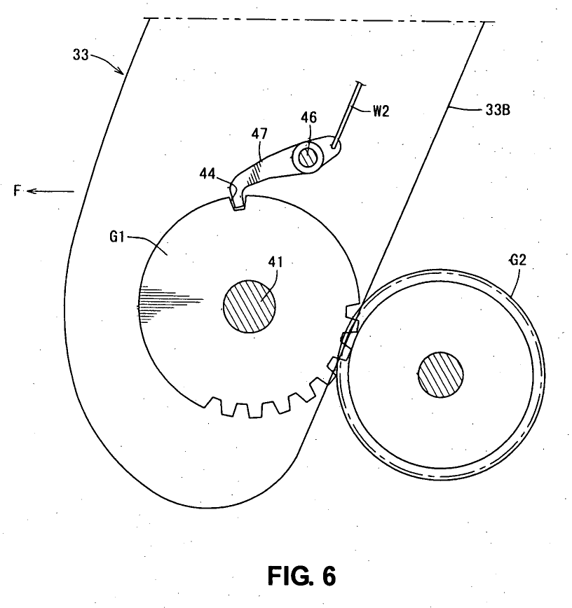

A circular plate 43 having recesses 43a, 43b is tightly connected to the rotational axis 41 via a key or the like, not illustrated, and a gear G1 having a recess 44 (see FIGS. 5 and 6) is loosely inserted to the rotational axis 41.

Above the circular plate 43, a lock lever 47 is attached to the seat back frame 42 via a bracket 45 and a support axis 46. Below the circular plate 43, meanwhile, another lock lever 49 is pivotally connected to the support plate 40 and a journal member 48.

Meanwhile, levers 50, 51 are provided at an upper shoulder portion of the seat back 33B. The lever 50 and the lower lock lever 49 are interconnected by a wire W1, and the lever 51 and the upper lock lever 47 are interconnected by a wire W2.

When the lever 50 is pulled, the lock lever 49 disengages with (unlocked) the recess 43b of the circular plate 43 via the wire W1, which makes a mode in which the seat back 33B can be independently operated, so the seat back 33B can be folded forward on the seat cushion 33C from its use state. Meanwhile, the other lever 51 is pulled, the lock lever 47 is moved to engage with the recess 43a of the circular plate 43 and the recess 44 of the gear G1 via the wire W2, which changes a state from an unlock state shown in FIG. 5 to a lock state shown in FIG. 6, in which the gear G1 can rotate as the seat back 33B moves (rotates).

The gear G1 has its gear portion to an extent of a rotating area of the seat back 33B as shown in FIGS. 5 and 6. A gear G3 to move the baggage-compartment board 36 is provided behind the gear G1 so as to engages with the gear G1 via an idle gear G2 as shown.

Herein, the gears G2, G3 are supported so as to be rotatable with respect to a vehicle side body (vehicle body side face portion). A link 52 is integrally formed with the gear G3 as shown in FIG. 3. The main board 36m of the baggage-compartment board 36 is coupled to a tip of the link 52 via a pin 53.

The above-described members G1, G2, G3, 52 form a linkage mechanism 54, which links a vertical movement of the baggage-compartment board 36 to a folding and returning movement of the seat back 33B.

Further, the members 47, W2, 51 form a control mechanism 55, which selects a linkage of movements of the seat back 33B and the baggage-compartment board 36 or a non-linkage thereof (or, in other words, limits a linkage of movement of the baggage-compartment board 36 with respect to movement of the seat back 33B). This mechanism 55 includes a lever 51 as a operational portion that a passenger manually operates. The unlock state shown in FIG. 5, where the lock lever 47 is moved by the lever 51 so as to disengage with the recess 44 of the gear G1, makes a mode in which the baggage-compartment board 36 can be vertically moved independently.

The above-described linkage mechanism 54 comprises a pair of mechanisms that are provided at both sides of between the seat back 33B and the baggage-compartment board 36 as shown in FIG. 2. A drive portion including the gear G1 is covered with a cover member 56 as shown in FIG. 4.

In the figures, an arrow F shows a vehicle forward direction, an arrow IN shows an vehicle inward direction, and an arrow OUT shows a vehicle outward direction.

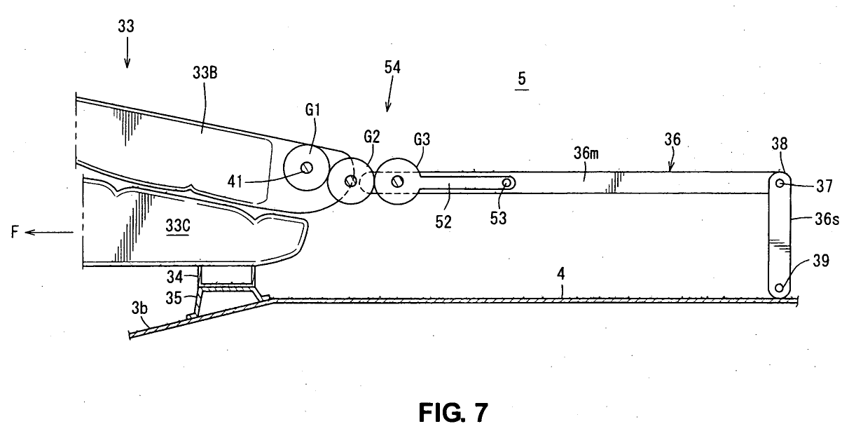

Operations of the above-described rear baggage compartment structure of a vehicle will be described. By pulling the lever-50 shown in FIG. 4, the lower lock lever 49 is moved via the wire W1 and disengages. Herein, the upper lock lever 47 remains in the state shown in FIG. 5 (unlock state). Accordingly, the seat back 33B in its use state shown in FIG. 3 can be moved independently to be folded on the seat cushion 33C as shown in FIG. 7. Namely, by selecting a non-linkage state of the control mechanism 55 as shown in FIGS. 4 and 5, the linkage of movement of the baggage-compartment board 36 with respect to the folding movement of the seat back 33B is limited to be disabled.

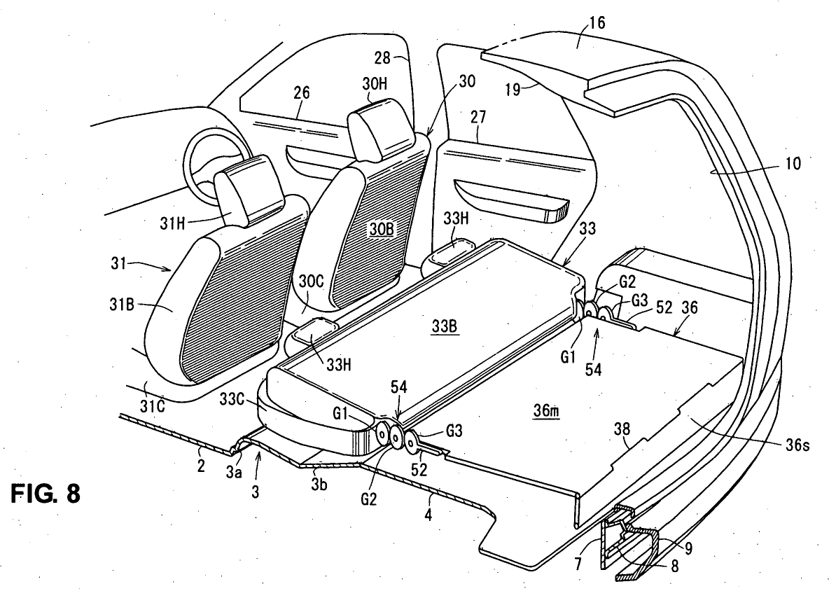

By pulling both of the levers 50, 51 shown in FIG. 4 at the same time, the lower lock lever 49 disengages and the upper lock lever 47 engages with the recess 43a of the circular plate 43 and the recess 44 of the gear G1 at the same time as shown in FIG. 6. Accordingly, when the baggage-compartment board 36 in the lower position shown in FIG. 3 is pulled upward with a manual operation, the members G1, G2, G3, 52 of the linkage mechanism 54 rotate in an arrow direction of FIG. 3. Thereby, a rotational force of the gear G1 is transmitted to the circular plate 43 via the lock lever 47 in the lock state, so the circular plate 43 drives the rotational axis 41 in a direction of seat back folding. As a result, as shown in FIGS. 7 and 8, the seat back 33B can be moved to be folded on the seat cushion 33C with a linkage of the upward movement of the baggage-compartment board 36.

A back face of the seat back 33b in the folded state shown in FIGS. 7 and 8 and an upper face of the main board 36m of the baggage-compartment board 36 form a substantially continuous and flat baggage-compartment face.

When the seat back 33B is returned to the use state from its folded state shown in FIGS. 7 and 8, the linkage of movements of the both 36, 33B by the linkage mechanism 54 can be disabled (non-linkage selection). Namely, when the lock lever 47 is operated to the state (unlock state) shown in FIG. 5 by the operation of the lever 51 of the control mechanism 55, only the seat back 33B can be retuned to its use state from its folded state. The baggage-compartment board 36 can be maintained in its upward-moved position shown in FIGS. 7 and 8.

Meanwhile, after the seat back 33B has been folded shown in FIGS. 7 and 8, the seat back 33B can be returned to the use state with the linkage of the downward movement of the baggage-compartment board 36 from its upper position. Namely, when the lock lever 47 is maintained in the state (lock state) shown in FIG. 6 by the operation of the lever 51 of the control mechanism 55, both the seat back 33B and the baggage-compartment board 36 move with the linkage by pushing down the baggage-compartment board 36 from its upper position. Thereby, the seat back 33B can be returned to the use state with the linkage of the downward movement of the baggage-compartment board 36.

Further, when only the baggage-compartment board 36 is moved downward from its upward-moved state shown in FIGS. 7 and 8, the linkage of movements of the both 36, 33B can be disabled (non-linkage selection) by unlocking the lock lever 47 as shown in FIG. 5 with the operation of the lever 51 of the control mechanism 55. Thereby, only the baggage-compartment board 36 can be moved to its lower position from its upper position, while the seat back 33B can be kept in its folded state.

According to the rear baggage compartment structure of a vehicle of the embodiment shown in FIGS. 1 to 10, the rear seat 33 with the seat cushion 33C and the seat back 33B is provided on the floor panel (see the kick-up floor portion 3b), the baggage compartment 5 is formed behind the rear seat 33, the rear seat 33 is configured to be foldable in such a manner that the seat back 33B is folded on the seat cushion 33C, and the baggage-compartment board 36 is provided in the baggage compartment 5. This board 36 is supported so as to move at least vertically, and there is provided the linkage mechanism 54 to operate the seat back 33B to be folded on the seat cushion 33C as the baggage-compartment board 36 moves upward.

According to the above-described structure, the seat back 33B can be folded on the seat cushion 33C with the linkage of movements as the baggage-compartment board 36 moves upward, and the difference in level between the back face of the folded seat back 33B and the baggage-compartment floor 36 can be diminished. Thereby, the operability at the baggage loading (unloading) can be improved.

Further, the back face of the seat back 33B in its folded state and the upper face of the baggage-compartment board 36 (specifically, the upper face of the main board 36m) that has moved upward form the substantially continuous baggage-compartment face. Thereby, both diminishing the difference in level and usage improvement of the baggage compartment can be attained by forming the substantially continuous baggage-compartment face.

Also, the linkage mechanism 54 comprises the control mechanism 55 to select the linkage of movements of the seat back 33B and the baggage-compartment board 36 or the non-linkage thereof. Thereby, in particular, the baggage-compartment board 36 can be move vertically independently from the seat back 33B by selecting the above-described non-linkage of movements.

In addition, the control mechanism 55 is operated by the passenger's operation. Thereby, the selection of the linkage or the non-linkage of movements can be attained by the passenger at need.

And, the control mechanism 55 is configured such that the baggage-compartment board 36 does not move as the seat back 33B is moved to be folded on the seat cushion 33C. Thereby, the seat back 33B can be folded independently.

Also, the control mechanism 55 is configured such that when the seat back 33B is operated to its use state after the seat back 33B has been folded on the seat cushion 33C, the non-linkage of movements of the baggage-compartment board 36 and the seat back 33B is selected. Thereby, the seat back 33B can be moved from its folded state (laying position) to its use state (upright position), keeping the baggage-compartment board 36 moved upward. Thus, the return movement of the seat back 33B to its used state can be attained while the baggage is placed on the baggage-compartment board moved upward. Thus, both baggage loading and passenger's sitting in the rear seat (many passengers) can be attained.

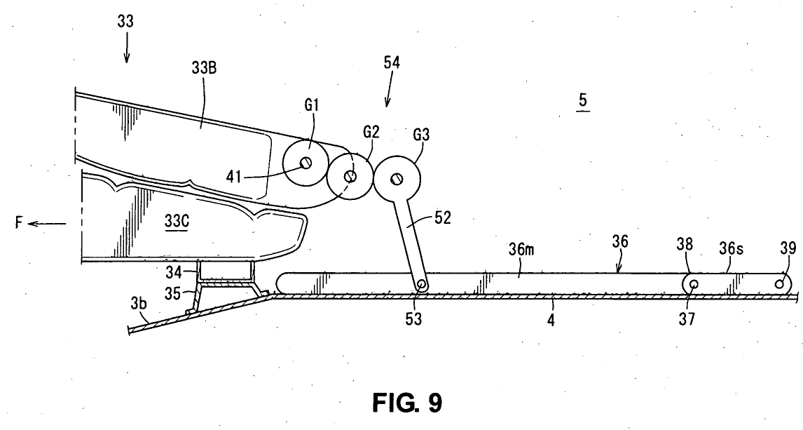

Furthermore, the linkage mechanism 54 comprises the control mechanism 55 that limits the linkage of movement of the baggage-compartment board 36 with respect to movement of the seat back 33B, allowing the linkage of movement of the seat back 33B with respect to the baggage-compartment board 36. Thereby, the seat back 33B can be folded independently, and there can be provided a deep and large baggage compartment with the seat back 33B that is folded and the baggage-compartment board 36 that is located below as shown in FIG. 9.

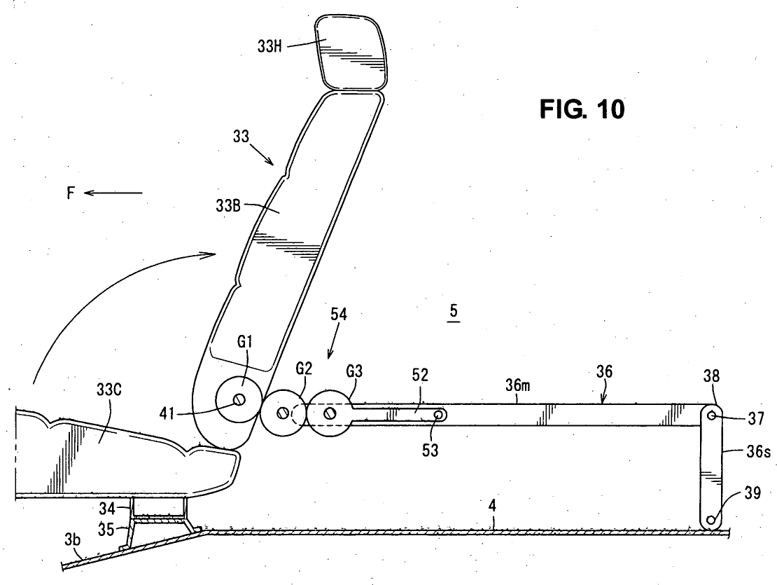

Also, the linkage mechanism 54 comprises the control mechanism 55 that limits the linkage of movement of the baggage-compartment board 36 with respect to movement of the seat back 33B when the seat back 33B is operated to its use state after the seat back 33B has been folded on the seat cushion 33C, allowing the linkage of movement of the baggage-compartment board 36 with respect to movement of the seat back 33B toward the folded state. Thereby, the seat back 33B can be returned to its use state, keeping the baggage-compartment board 36 moved upward as shown in FIG. 10. Namely, both passenger's sitting in the seat 33 and baggage loading onto the baggage-compartment board 36 can be attained.

Further, the linkage mechanism 54 comprises the control mechanism 55 that limits the linkage of movement of the baggage-compartment board 36 with respect to movement of the seat back 33B when the seat back 33B is moved toward its folded state and when the seat back 33B is operated to its use state after the seat back 33B has been folded on the seat cushion 33C. Thereby, ensuring the linkage of movements of the baggage-compartment board 36 and the seat back 33B with the linkage mechanism 54, the seat back 33B can be folded independently as shown in FIG. 9 or returned to its use state from its folded state as shown in FIG. 3 with the control mechanism 55.

Additionally, the control mechanism 55 comprises the operational portion (see the lever 51) to select the linkage state or the linkage limitation state, which is selected by the operation of the passenger. Thereby, selection of linkage or linkage limitation (non-linkage) of movements can be conduced easily with the passenger's operation of the operational portion (see the lever 51) at need, so operability at the baggage loading or passenger's additional ingress can be improved.

### Embodiment 2

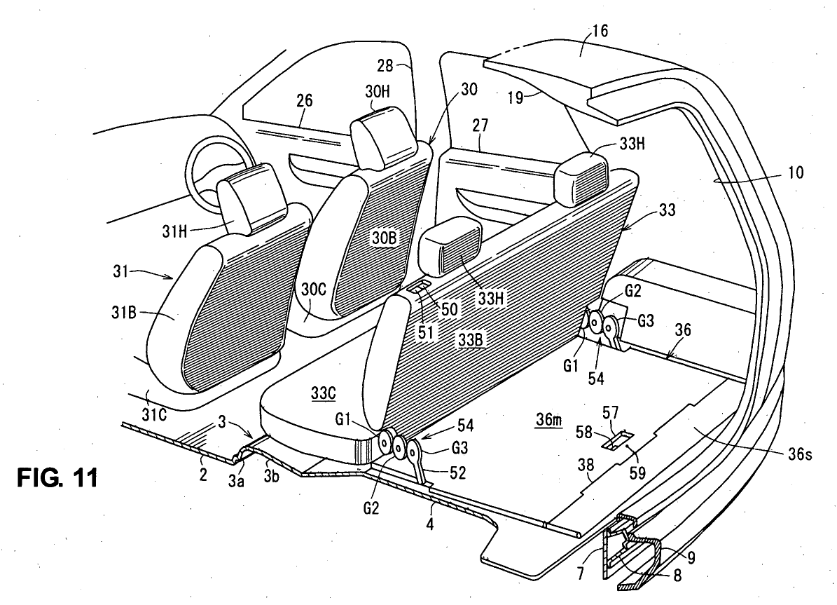

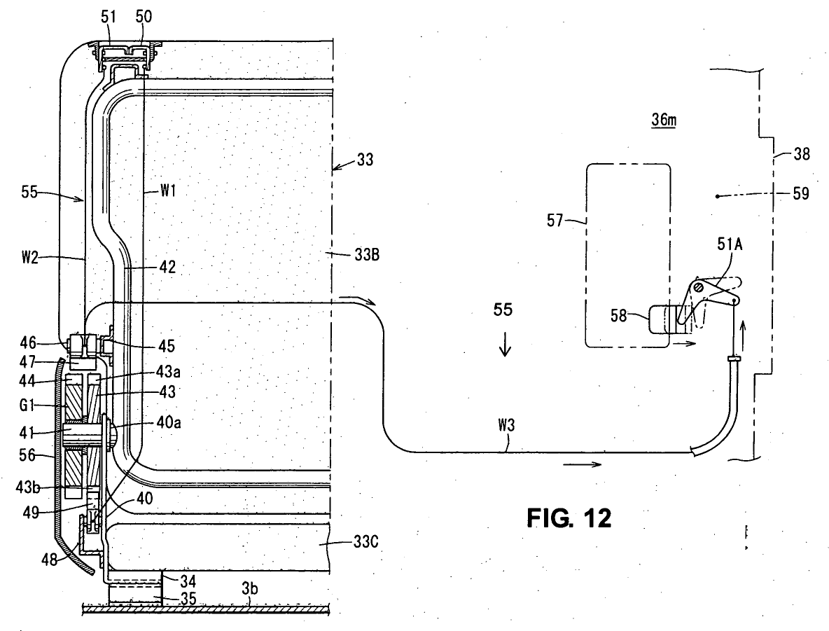

FIGS. 11 to 13 show another embodiment of the rear baggage compartment structure of a vehicle. As shown in FIGS. 11 and 12 (a left part of FIG. 12 is a sectional view similar to FIG. 4, a right part of FIG. 12 is a plan view of a major portion of FIG. 11, thus FIG. 12 is a combined system diagram), there is provided an opening portion 57 to allow a passenger's hand to therein at the main board 36m of the baggage compartment board 36. The opening portion 57 and part of the main board 36m forms a handle portion 59. A lever 51A is pivotally supported at the handle portion 59, which performs a similar function to the lever 51 provided at the upper shoulder portion of the seat back 33B. One end of this lever 51A and the lock lever 47 are interconnected by a wire W3. At the handle portion 59 is provided a slider 58 to operate the other end of the lever 51A. Thus, the slider 58 may be operated by the passenger's hand being inserted through the opening portion 57.

Namely, by operating the other end of the lever 51A with the slider 58, the lever 51A rotates from a state shown by a solid line to another state shown by a broken line in FIG. 12. Thereby, the wire W3 is pulled in an arrow direction in FIG. 12, and then the lock lever 47 comes to engage with the recess 43a of the circular plate 43 and the recess 44 of the gear G1 at the same time, which makes the lock state (linkage mode) shown in FIG. 6.

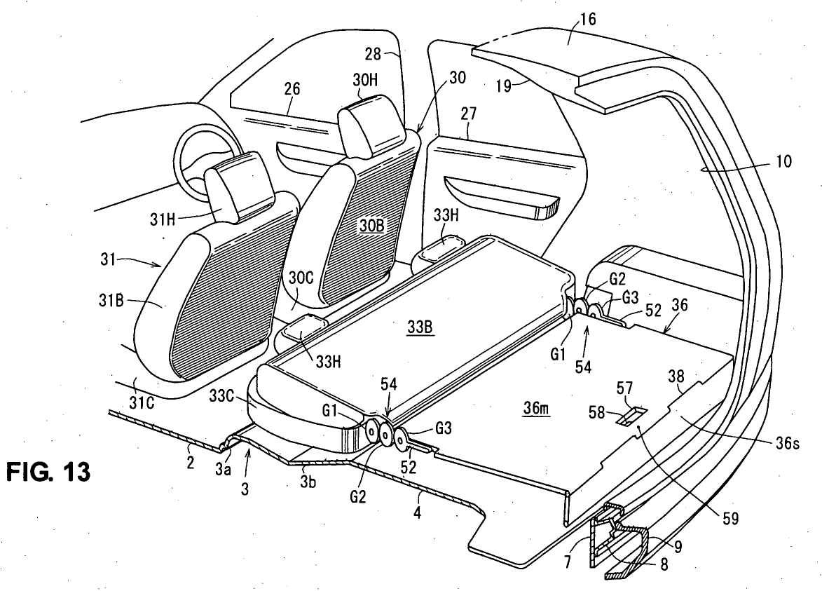

Namely, the embodiment disclosed in FIGS. 11 to 13 has the members 57, 58, 51A and W3 that are added to the embodiment disclosed in FIGS. 1 to 10. The slider 58, lever 51A, wire W3 and lock lever 47 form the control mechanism 55, in which the linkage or the non-linkage of movements of the baggage-compartment board 36 and the seat back 33B is selected with the slider 58. Accordingly, in the present embodiment, when the baggage-compartment board 36 is pushed down after operating the lock lever 47 to engage with the recesses 43a, 44 with the slider 58 in a state shown in FIG. 13 where the seat back 33B is folded on the seat cushion 33C and the baggage-compartment board 36 is located in the upper position, the seat back 33B can be returned to its use state of FIG. 11 by the linkage of the downward movement of the baggage-compartment board 36.

Thus, the linkage mechanism 54 of the embodiment of FIGS. 11 to 13 comprises the slider 58 as an operational portion that is provided so as to be operative from a side of the baggage-compartment board 36 to select the linkage of movements of the seat back 33B and the baggage-compartment board 36 or the non-linkage. Thereby, the selection of linkage or non-linkage of movements can be attained by using the operation portion (slider 58) located on the side of the baggage-compartment board 36 at the upward/downward movement of the baggage-compartment board 36, so the operability can be improved.

Structures, operations and effects of other components of the present embodiment shown in FIGS. 11 to 13 are substantially the same as those of the components of the previous embodiment shown in FIGS. 1 to 10. Accordingly, identical reference characters are applied to the same components and detailed descriptions of those components are omitted here.

### Embodiment 3

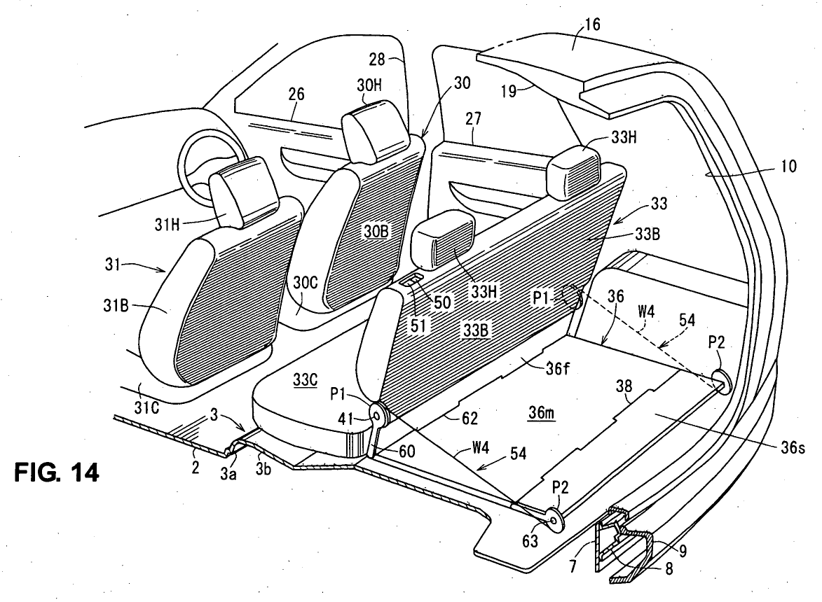

FIGS. 14 to 18 show further another embodiment of the rear baggage compartment structure of a vehicle. The previous embodiments 1 and 2 apply the linkage mechanism 54 with the gear connecting structure, but the present embodiment of FIGS. 14 to 18 uses the linkage mechanism 54 that comprises pulleys P1, P2 and a wire W4.

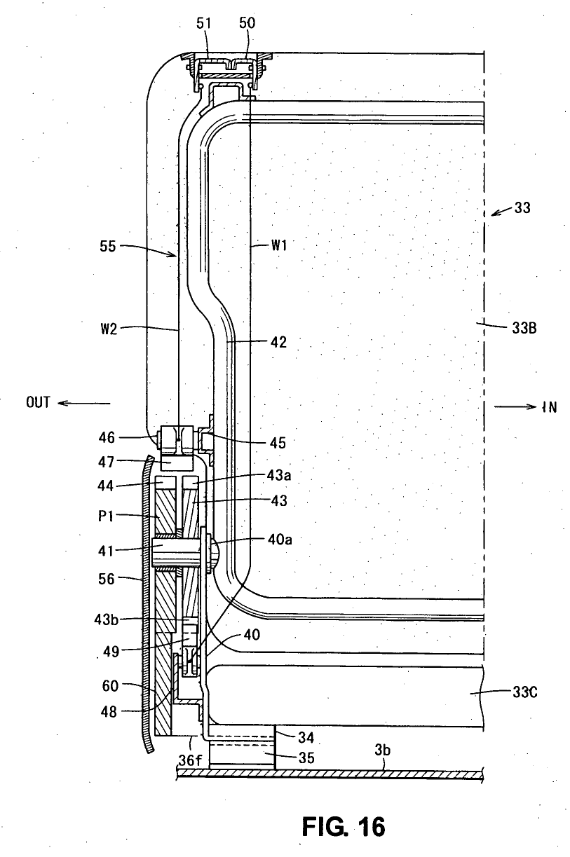

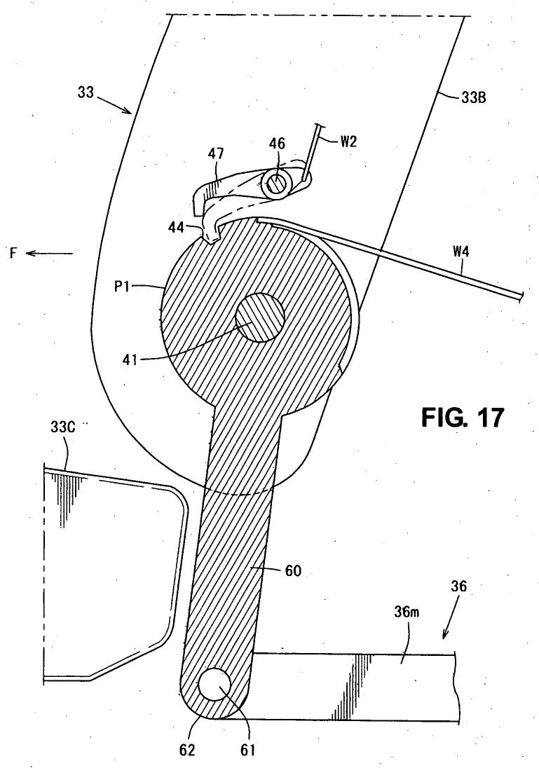

Namely, the pulley P1 is loosely inserted to the rotational axis 41 shown in FIG. 16, which has the recess 44 as shown in FIGS. 16 and 17. A link portion 60 is integrally formed with the pulley P1.

The pulley P1 is formed of a pair of pulley members that are disposed at both-side lower faces of the seat back 33B as shown in FIG. 14. Between the pulleys P1, P1 and the link portions 60, 60 are provided a front board 36f that extends in the vehicle width direction.

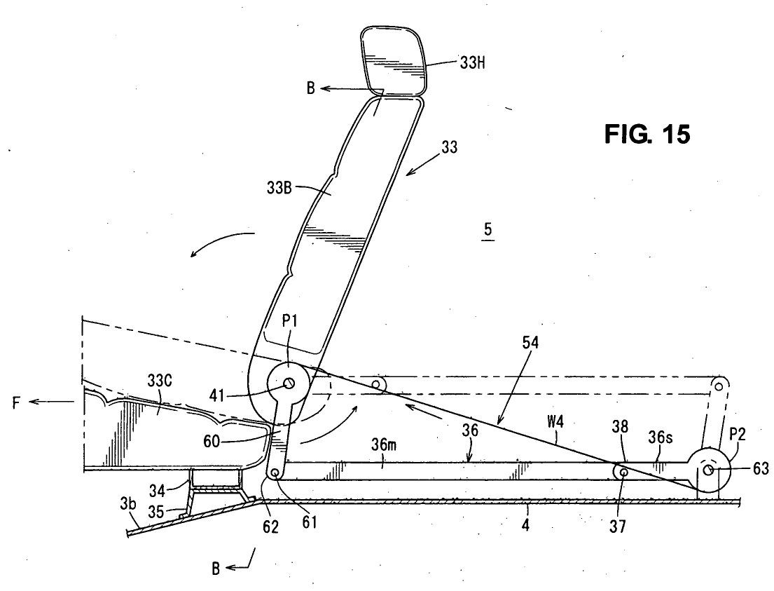

Namely, the baggage-compartment board 36 comprises the front board 36f, main board 36m and sub board 36s that are split into three parts (plural split). One end of the front board 36f and the front end of the main board 36m are pivotally coupled via a hinge portion 62 including a hinge pin 61 (see FIG. 15). Herein, a rear end of the main board 36m and one end of the sub board 36s are pivotally coupled via the hinge portion 38 including the hinge pin 38, which is the same as the previous embodiment.

The pulleys P2, P2 are provided at both-side base end portions of the sub board 36s. pulley axes 63, 63 of the pulleys P2, P2 are pivotally supported at a body such as the baggage-compartment floor 4. Between the pulley P1 at the seat back 33B and the pulley P2 at the baggage-compartment floor 4 is provided the wire W4 for providing a continuous movement. Namely, in the present embodiment, the pulleys P1, P2, link portion 60 and wire W4 form the linkage mechanism 54, in which the movement of the baggage-compartment board 36 is effectively utilized as a help of the movement linkage of the linkage mechanism 54. Herein, the lock lever 47, wire W2, lever 51 form the control mechanism 55.

Hereinafter, the operations of the above-described rear baggage compartment structure will be described. By only pulling the lever 50 shown in FIG. 16, the lower lock lever 49 is moved via the wire W1 and disengages. Herein, the upper lock lever 47 remains in the state shown in FIG. 17 (unlock state). Accordingly, the seat back 33B in its use state shown in FIG. 15 can be moved independently to be folded on the seat cushion 33C as shown by a broken line in FIG. 15.

Namely, by selecting an non-linkage state of the control mechanism 55 as shown by the solid line in FIGS. 16 and 17, the linkage of movement of the baggage-compartment board 36 with respect to the folding movement of the seat back 33B can be limited to be disabled.

By pulling the both levers 50, 51 shown in FIG. 16 at the same time, the lower lock lever 49 disengages and the upper lock lever 47 engages with the recess 43a of the circular plate 43 and the recess 44 of the gear G1 at the same time as shown by the broken line in FIG. 17. Accordingly, when the baggage-compartment board 36 in the lower position shown in FIG. 15 is pulled upward with the manual operation, the members P2, 54, 60, P1 of the linkage mechanism 54 rotate in an arrow direction of FIG. 15. Thereby, a rotational force of the pulley P1 is transmitted to the circular plate 43 via the lock lever 47 in the lock state, so the circular plate 43 drives the rotational axis 41 in a direction of seat back folding. As a result, as shown by the broken line in FIG. 15 and the solid line in FIG. 17, the seat back 33B can be moved to be folded on the seat cushion 33C with the linkage of the upward movement of the baggage-compartment board 36.

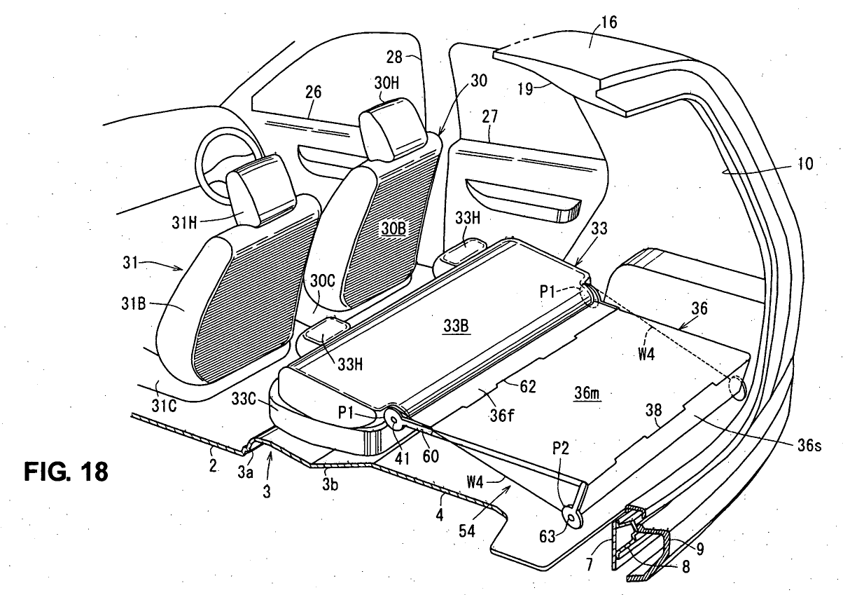

The back face of the seat back 33b in the folded state shown in FIG. 18 and the upper face of the main board 36m of the baggage-compartment board 36 form a substantially continuous and flat baggage-compartment face.

When the seat back 33B is returned to the use state from its folded state shown by the broken line in FIG. 15, the linkage of movements of the both 36, 33B by the linkage mechanism 54 can be limited so as to be disabled (non-linkage selection). Namely, when the lock lever 47 is operated to the state (unlock state) shown by the solid line in FIG. 16 by the operation of the lever 51 of the control mechanism 55, only the seat back 33B can be retuned to its use state from its folded state. The baggage-compartment board 36 can be kept in its upward-moved position shown by the broken line in FIG. 15.

Meanwhile, after the seat back 33B has been folded shown by the broken line in FIG. 15, the seat back 33B can be returned to the use state with the linkage of the downward movement of the baggage-compartment board 36 from its upper position. Namely, when the lock lever 47 is maintained in the state (lock state) shown by the broken line in FIG. 17 by the operation of the lever 51 of the control mechanism 55, both boards 36m, 36s move with the linkage by pushing down the baggage-compartment board 36 from its upper position. Thereby, the pulley P2 rotates counterclockwise in FIG. 15, and the wire W4 is pulled rearward. Then, the pulley P1 is rotated in a direction of raising the seat back. Thus, the rotational force of the pulley P1 is transmitted to the circular plate 43 via the lock lever 47, and thereby the rotational axis 41 is driven in the direction of raising the seat back. As a result, the seat back 33B can be returned to the use state with the linkage of the downward movement of the baggage-compartment board 36.

Further, when only the baggage-compartment board 36 is moved downward from its upward-moved state shown by the broken line in FIG. 15, the linkage of movements of the both 36, 33B can be limited to be disabled (non-linkage selection) by unlocking the lock lever 47 as shown by the solid line in FIG. 17 with the operation of the lever 51 of the control mechanism 55. Thereby, the linkage of movements of the both members 36, 33B is disabled, so only the baggage-compartment board 36 can be moved to its lower position from its upper position, and the seat back 33B can be maintained in its folded state.

Also, when the seat back 33B is folded forward, by pulling only the lever 50 to unlock the lock lever 49 via the wire W1 and maintaining the upper lock lever 47 in the limitation mode shown by the solid line in FIG. 17, the linkage of the upward movement of the baggage-compartment board 36 can be limited with respect to the folding movement of the seat cushion 33B on the seat cushion 33C from the upright position shown by the solid line in FIG. 15. The baggage-compartment board 36 is remained in its lower position as shown by the solid line in FIG. 15.

Herein, although there exists a difference in level between the back face of the seat back 33B and the baggage-compartment floor 4, a continuous and deep baggage-compartment space is formed. Thus, the control mechanism 55 can limit the linkage of movement of the baggage-compartment board 36 with respect to movement of the seat back 33B, allowing the linkage of the movement of seat back 33B with respect to the baggage-compartment board 36.

Also, the control mechanism 55 can limit the linkage of movement of the baggage-compartment board 36 with respect to movement of the seat back 33B when the seat back 33B is operated to its use state after the seat back 33B has been folded on the seat cushion 33C, allowing the linkage of movement of the baggage-compartment board 36 with respect to movement of the seat back 33B toward the folded state.

Namely, when the seat back 33B is moved from the upright state (use state) shown by the solid line in FIG. 15 to the folded state, both levers 50, 51 of FIG. 16 are pulled at the same time to make the lower lock lever 49 disengage and make the upper lover 47 engage with the recess 44 of the pulley P1 and the recess 43a of the circular plate 43, thereby making the linkage mode shown by the broken line in FIG. 17. Thereby, the pulleys P1, P2, link portion 60, and wire W4 are driven in the arrow direction in FIG. 15 as the seat back 33B is operated to be folded. Accordingly, the baggage-compartment board 36 can be moved upward, as shown by the broken line in FIG. 15, with the linkage of the folding movement of the seat back 33B.

In the state where the baggage-compartment board 36 is in the upper position shown by the broken line in FIG. 15, when the seat back 33B is returned to its use state shown by the solid line from its folded state shown by the broken line in FIG. 15, the linkage of the movement of the baggage-compartment board 36 with the respect to the manual operation to move the seat back 33B from its lying position to its upright position is limited when the upper lock lever 47 is in the limitation mode shown by the solid line in FIG. 17 by the operation of the lever 51. Thereby, the baggage-compartment board 36 is kept in the upper position, so the seat back 33B can be returned to the use state with the baggage-compartment board 36 with any baggage placed on it.

Thus, the control mechanism 55 can limit the linkage of movement of the baggage-compartment board 36 with respect to movement of the seat back 33B when the seat back 33B is operated to its use state after the seat back 33B has been folded on the seat cushion 33C, allowing the linkage of movement of the baggage-compartment board 36 with respect to movement of the seat back 33B toward the folded state.

Further, the control mechanism 55 can limit the linkage of movement of the baggage-compartment board 36 with respect to movement of the seat back 33B when the seat back 33B is moved toward its folded state and when the seat back 33B is operated to its use state after the seat back 33B has been folded on the seat cushion 33C.

Namely, when the seat back 33B is moved from the use state shown by the solid line in FIG. 15 to the folded state shown by the broken line, only the lever 50 is pulled to unlock the lower lock lever 49 via the wire W1 and the limitation mode is kept with the lock lever 47 (shown by the solid line in FIG. 17). Thereby, the baggage-compartment board 36 is not moved upward even when the seat back 33B is moved to be folded on the seat cushion 33C as shown by the broken line from its use state shown by the solid line in FIG. 15. Also, even when the seat back 33B is retuned to the use state shown by the solid line from its folded state shown by the broken line in FIG. 15, the baggage-compartment board 36 keeps its position located below.

Thus, the control mechanism 55 limits the linkage of movement of the baggage-compartment board 36 with respect to movement of the seat back 33B both of the time when the seat back 33B is moved toward its folded state and when the seat back 33B is operated to its use state after the seat back 33B has been folded on the seat cushion 33C, allowing only the seat back 33B to move upward independently.

As described above, the linkage mechanism comprising the pulleys P1, P2 and wire W4 that are shown in FIGS. 14 to 18 is applicable as the connecting mechanism 54 in place of the gear connecting structure of the previous embodiment 1. Thus, this linkage mechanism performs substantially the same operations and effects as that of the previous embodiment 1. Accordingly, identical reference characters are applied to the same components in FIGS. 14 to 18 and detailed descriptions of those components are omitted here.

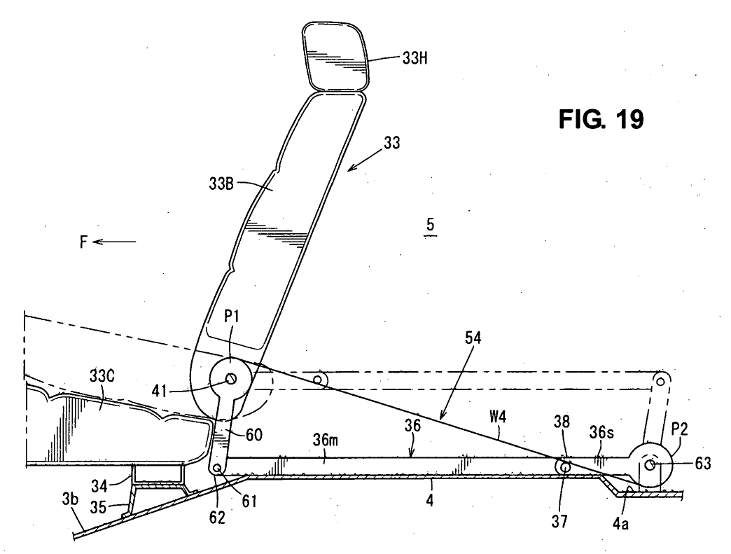

A structure shown in FIG. 19 may be applied in place of the structure shown in FIG. 15. Namely, a recess 4a may be formed at a portion of the baggage-compartment floor 4 where the pulley P2 is disposed in such a manner that the wire W4 does not interfere with the recess 4a and the lower faces of the main board 36m and the sub board 36s contact the upper face of the baggage-compartment floor 4.

Thereby, the baggage (weight of the baggage) placed on the baggage-compartment board 36 in the lower position can be received at the baggage-compartment floor 4, so durability of the baggage-compartment board 36 can be improved.

The present invention should not be limited to the above-described embodiments, and any other modifications and improvements may be applied within the scope of a sprit of the present invention.

What is claimed is:

1. A rear baggage compartment structure of a vehicle, comprising:
a seat provided on a floor panel of a vehicle body, the seat including a seat cushion and a seat back, the seat being configured to be foldable in such a manner that the seat back is folded on the seat cushion;
a baggage compartment formed behind the seat;
a baggage-compartment board provided in the baggage compartment, the board being supported so as to move at least vertically; and
a linkage mechanism to operate the seat back of the seat to be folded on the seat cushion as the baggage-compartment board moves upward.

2. The rear baggage compartment structure of a vehicle of claim 1, wherein a back face of the seat back in a folded state and an upper face of the baggage-compartment board that has moved upward form a substantially continuous baggage-compartment face.

3. The rear baggage compartment structure of a vehicle of claim 1 wherein said linkage mechanism comprises a control mechanism to select a linkage of movements of the seat back and the baggage-compartment board or a non-linkage thereof.

4. The rear baggage compartment structure of a vehicle of claim 3, wherein said control mechanism is operated by an operation of a passenger.

5. The rear baggage compartment structure of a vehicle of claim 3, wherein said control mechanism is configured such that the baggage-compartment board does not move as the seat back is moved to be folded on the seat cushion.

6. The rear baggage compartment structure of a vehicle of claim 3, wherein said control mechanism is configured such that when the seat back is operated to a use state thereof after the seat back has been folded on the seat cushion, the non-linkage of movements of the baggage-compartment board and the seat back is selected.

7. The rear baggage compartment structure of a vehicle of claim 1, wherein said linkage mechanism comprises an operational portion that is provided so as to be operative from a side of the baggage-compartment board to select a linkage of movements of the seat back and the baggage-compartment board or a non-linkage thereof.

8. The rear baggage compartment structure of a vehicle of claim 1, wherein said linkage mechanism comprises a control mechanism that limits a linkage of movement of the baggage-compartment board with respect to movement of the seat back, allowing a linkage of movement of seat back with respect to movement of the baggage-compartment board.

9. The rear baggage compartment structure of a vehicle of claim 1, wherein said linkage mechanism comprises a control mechanism that limits a linkage of movement of the baggage-compartment board with respect to movement of the seat back when the seat back is operated to a use state thereof after the seat back has been folded on the seat cushion, allowing a linkage of movement of the baggage-compartment board with respect to movement of the seat back toward a folded state.

10. The rear baggage compartment structure of a vehicle of claim 1, wherein said linkage mechanism comprises a control mechanism that limits a linkage of movement of the baggage-compartment board with respect to movement of the seat back when the seat back is moved toward a folded state and when the seat back is operated to a use state thereof after the seat back has been folded on the seat cushion.

11. The rear baggage compartment structure of a vehicle of claim 8, wherein said control mechanism comprises an operational portion to select a linkage state or a linkage limitation state, which is selected by an operation of a passenger.

12. The rear baggage compartment structure of a vehicle of claim 9, wherein said control mechanism comprises an operational portion to select a linkage state or a linkage limitation state, which is selected by an operation of a passenger.

13. The rear baggage compartment structure of a vehicle of claim 10, wherein said control mechanism comprises an operational portion to select a linkage state or a linkage limitation state, which is selected by an operation of a passenger.
